(19) United States
(12) Patent Application Publication
(10) Pub. No.: US 2025/0254010 A1
(43) Pub. Date: Aug. 7, 2025

(54) ELECTRONIC DEVICE, COMMUNICATION METHOD AND COMPUTER PROGRAM PRODUCT

(71) Applicant: Sony Group Corporation, Tokyo (JP)

(72) Inventors: Fawang LIN, Chengdu, Sichuan (CN); Jingwei YE, Chengdu, Sichuan (CN); Ying-Chang LIANG, Chengdu, Sichuan (CN); Shuo WANG, Chaoyang District, Beijing (CN); Chen SUN, Chaoyang District, Beijing (CN)

(73) Assignee: Sony Group Corporation, Tokyo (JP)

(21) Appl. No.: 18/854,983

(22) PCT Filed: Apr. 11, 2023
(86) PCT No.: PCT/CN2023/087496

§ 371 Date: Oct. 8, 2024

(30) Foreign Application Priority Data
Apr. 15, 2022 (CN) 202210397524.3

(51) Int. Cl. H04L 5/00; H04L 43/10; H04W 16/14; H04W 72/0453; H04W 72/541

(52) U.S. Cl. CPC H04L 5/0073; H04L 43/10; H04W 16/14; H04W 72/0453; H04W 72/541

(57) ABSTRACT

The present disclosure relates to an electronic device, a communication method and a computer program product. An electronic device for a General Authorized Access (GAA) user comprises processing circuitry configured to: inquire a Priority Access License (PAL) user for spectrum availability information on a Citizen Broadband Radio Service (CBRS) system; in absence of available frequency bands, receive from said PAL user at least one interference margin allocation scheme proposed by one or more PAL users; based on a particular interference margin allocation scheme of the at least one interference margin allocation scheme, initiate a CBRS system spectrum access procedure with a Spectrum Access System (SAS).

### CROSS REFERENCE TO RELATED APPLICATIONS

The present application claims the benefit of Chinese patent application No. 202210397524.3 filed on Apr. 15, 2022, which is entirely incorporated herein by reference.

### FIELD OF THE INVENTION

The present disclosure relates to the field of wireless communication, and more particularly, to an electronic device, a communication method, and a computer program product that provide an improved spectrum access to a Citizens Broadband Radio Service (CBRS) system.

### BACKGROUND

Over many years of effort, the U.S. Federal Communications Commission (FCC) promulgated its national broadband program-Citizens Broadband Radio Service (CBRS). The CBRS involves the frequency range of 3550-3700 MHZ, a part of which was ever at disposal of the U.S. federal government. In 2017, the FCC completed the rule establishment for commercial usage of this frequency band, making the 150 MHz spectrum applicable to mobile broadband and other commercial users.

The CBRS employs a three-tier spectrum authorization framework, including Incumbent Access, Priority Access License (PAL), and General Authorized Access (GAA), allowing various commercial users and incumbent federal/non-federal users to share the frequency band of 3550-3700 MHZ. In this solution, all CBRS devices (CBSDs) need to be authorized by a centralized Spectrum Access System (SAS) to use the frequency band, however, this conventional architecture makes the SAS take overly management responsibilities and is prone to a single point of failure.

Furthermore, GAA users do not enjoy interference protection according to the three-tier spectrum authorization rules. To coordinate interferences between GAA devices, a coexistence manager (CxM) groups CBSDs into different coexistence groups (CxG) to limit interferences of lower-tier users to upper-tier users, especially to incumbent users. The PAL and GAA users can use this frequency band to transmit information while ensuring that an aggregate interference at Protection Points (PP) within an incumbent user's Protection Zone (PZ) is within a certain threshold. However, there is not a perfect mechanism for managing the threshold of interferences experienced by the incumbent users in related arts.

Therefore, there is a need for an improve method of managing the threshold of interferences to the incumbent users to enable more users to access the system spectrum.

### SUMMARY OF THE INVENTION

The present disclosure provides a number of aspects, and conceptually provides a novel mechanism for PAL users to bear a part of management functions for the CBRS spectrum access. The above-described need may be met by applying one or more aspects of the present disclosure.

A brief summary regarding the present disclosure is given here to provide a basic understanding on some aspects of the present disclosure. However, it will be appreciated that the summary is not an exhaustive description of the present disclosure. It is not intended to identify key portions or important portions of the present disclosure, nor to limit the scope of the present disclosure. It aims at merely describing some concepts about the present disclosure in a simplified form and serves as a preorder of a more detailed description to be given later.

According to one aspect of the present disclosure, there is provided an electronic device for a General Authorized Access (GAA) user, comprising processing circuitry configured to inquire a Priority Access License (PAL) user for spectrum availability information on a Citizen Broadband Radio Service (CBRS) system; in absence of available frequency bands, receive from said PAL user at least one interference margin allocation scheme proposed by one or more PAL users; and based on a particular interference margin allocation scheme of the at least one interference margin allocation scheme, initiate a CBRS system spectrum access procedure with a Spectrum Access System (SAS).

According to one aspect of the present disclosure, there is provided an electronic device for a Priority Access License (PAL) user, comprising processing circuitry configured to receive, from a General Authorized Access (GAA) user, an inquiry for spectrum availability information on a Citizen Broadband Radio Service (CBRS) system; and in absence of available frequency bands, send to the GAA user at least one interference margin allocation scheme proposed by one or more PAL users.

According to one aspect of the present disclosure, there is provided an electronic device for a Priority Access License (PAL) user, comprising processing circuitry configured to in response to an inquiry for spectrum availability information on a Citizen Broadband Radio Service (CBRS) system from a General Authorized Access (GAA) user broadcast by another PAL user, propose an interference margin allocation scheme indicating a frequency band and an interference margin that can be provided to the GAA user by the PAL user; and send the interference margin allocation scheme to the another PAL user.

According to one aspect of the present disclosure, there is provided a communication method comprising: inquiring a Priority Access License (PAL) user for spectrum availability information on a Citizen Broadband Radio Service (CBRS) system; in absence of available frequency bands, receiving from said PAL user at least one interference margin allocation scheme proposed by one or more PAL users; and based on a particular interference margin allocation scheme of the at least one interference margin allocation scheme, initiating a CBRS system spectrum access procedure with a Spectrum Access System (SAS).

According to one aspect of the present disclosure, there is provided a communication method comprising: receiving, from a General Authorized Access (GAA) user, an inquiry for spectrum availability information on a Citizen Broadband Radio Service (CBRS) system; and in absence of available frequency bands, sending the GAA user at least one interference margin allocation scheme proposed by one or more PAL users.

According to one aspect of the present disclosure, there is provided a computer program product comprising executable instructions which, when executed, implement any of the above communication methods.

### DESCRIPTION OF THE DRAWINGS

A better understanding of the present disclosure may be achieved by referring to a detailed description given hereinafter in connection with accompanying drawings, wherein the same or similar reference signs are used to indicate the same or similar elements throughout the drawings. The drawings are to be included in the specification and form a part of the specification along with the following detailed descriptions, for further illustrating embodiments of the present disclosure and for explaining the theory and advantages of the present disclosure. Wherein,

FIG. 1 is a schematic diagram of a three-tier spectrum authorization framework of a CBRS system;

FIG. 2 is an exemplary SAS architecture for a CBRS system;

FIG. 3 illustrates an exemplary scenario of a CBRS system;

FIG. 4 conceptually illustrates a CBRS spectrum access method according to the present disclosure;

FIG. 5 illustrates a flowchart according to an example embodiment of the present disclosure;

FIG. 6 illustrates a flowchart according to another exemplary embodiment of the present disclosure;

FIG. 7 illustrates a flowchart according to yet another exemplary embodiment of the present disclosure;

FIGS. 8 and 9 show simulation diagrams according to the present disclosure;

FIGS. 10A and 10B illustrate an electronic device for a GAA user and a communication method thereof according to the present disclosure;

FIGS. 11A and 11B illustrate an electronic device for a PAL user and a communication method thereof according to the present disclosure;

FIGS. 12A and 12B illustrate an electronic device for a PAL user and a communication method thereof according to the present disclosure;

FIG. 13 illustrates a first example of schematic configuration of a base station according to the present disclosure;

FIG. 14 illustrates a second example of schematic configuration of a base station according to the present disclosure;

Further features and aspects of the present disclosure will become apparent from the following description with reference to the attached drawings.

### DETAILED DESCRIPTION OF PREFERRED EMBODIMENTS

Various illustrative embodiments of the present disclosure will be described hereinafter with reference to the drawings. For purpose of clarity and simplicity, not all implementations of the embodiments are described in the specification. Note that, however, many settings specific to the implementations can be made according to specific requirements in practicing the embodiments of the present disclosure, so as to achieve specific goals of the developers, for example, to comply with constraints related to the device or business, which may vary from implementations.

In addition, it should be noted that to avoid obscuring the present disclosure with unnecessary details, the figures illustrate only steps of a process and/or components of a device that are closely related to the technical solutions according to the present disclosure, and omit details that have little relation to the present disclosure.

For convenient explanation of the technical solutions of the present disclosure, various aspects of the present disclosure will be described below in a context of the CBRS. However, it should be noted that this is not a limitation on the scope of application of the present disclosure. Shared spectrums similar to the CBRS are being planned in Europe and elsewhere. Therefore, one or more aspects of the present disclosure can also be similarly applied to another wireless communication system utilizing a multi-tier spectrum authorization frame. The architecture, entities, functions, processes and the like as described in the following description are not limited to those in the CBRS communication system, and can be found in other communication standards.

### Overview

The United States (USA) creates a new Citizens Broadband Radio Service (CBRS) in the 3.5 GHz band currently occupied by incumbent users such as Department of Defense, which will increase the exigent capacity to meet growing wireless communication demands. The CBRS more positively applies the concept of authorized shared access to spectrum. The CBRS is unique in providing a relatively large amount of spectrum (frequency bandwidth) without expensive auctions and without contact with a particular operator or service provider.

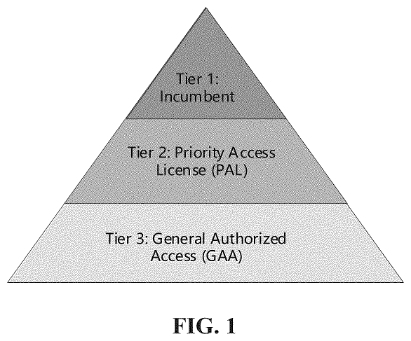

The FCC has specified a three-tier spectrum authorization framework for 3550-3700 MHz. FIG. 1 illustrates a schematic diagram of such three-tier frame. Incumbent users at the highest tier include federal users operating in the 3.5 GHz band, such as U.S. navy radars, and grandfather Fixed Satellite Service (FSS) users. These users will be protected from harmful interferences from users at the two lower tiers.

The second tier consists of users who obtain Priority Access Licenses (PALs). The FCC will auction for 100 MHz (e.g., 3550-3650 MHz) in the 150 MHz spectrum. Each PAL can obtain a 10 MHz band in a single “census block” with a license plate life of three years, and a holding volume of the PALs per census block must not exceed seven, of which up to four PALs may be owned by any single applicant.

The third tier encompasses any user with authorized 3.5 GHz devices, i.e., General Authorized Access (GAA) user, allowing open and flexible access to the spectrum for as wide range of potential user groups as possible. The GAA users may use any portion of the full 150 MHz spectrum that is not allocated to higher-priority users for free or may operate opportunistically on unused PAL channels.

In the three-tier framework described above, the incumbent users at the highest tier may enjoy the highest level of interference protection from signal interferences from the PAL users and the GAA users, and the PAL users may enjoy limited protection from signal interferences from the users at the third tier. The GAA users do not enjoy any protection. The second and third tiers are supervised by the CBRS, and their CBSDs can only operate under authorization of a centralized SAS. The SAS implements policy management functions and geographic location databases for protection of the incumbent users and implements hierarchical access. The SAS maintains current information about registered CBSDs, geographic locations and configurations of the protected FSS, and exclusion zones and protection zones of the federal incumbent users.

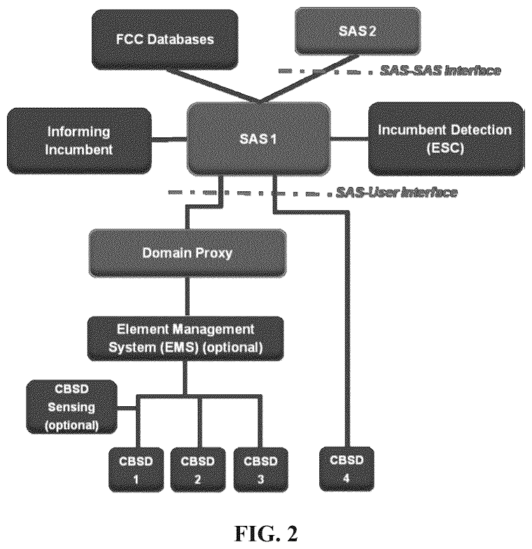

FIG. 2 depicts an exemplary SAS architecture for the CBRS system. The SAS may be considered a central entity or system for coordinating, authorizing, and managing the use of CBRS spectrum, protecting the operations at higher tiers from interferences, and maximizing the frequency capacity of all CBRS operators. In some cases, the SAS may be referred to as a control node. The SAS administrator may charge CBRS users for registration and frequency coordination services. There may be one or more SAS, such as SAS1 and SAS2 connected to each other.

The SAS may have the following functionalities: (1) CBSD registration; (2) interference analysis; (3) incumbent protection; (4) PAL license verification; (5) CBSD channel assignment; (6) CBSD power limitation; (7) PAL protection; and (8) cooperation between SASs. As shown in FIG. 2, for example, SAS1 is connected to FCC databases, an Environment Sensing Capability (ESC) system for incumbent detection, an informing incumbent system, a domain proxy, and CBSDs (e.g., CBSD4).

The FCC database includes information related to business users and corresponding licenses (e.g., site-based license information). SAS1 and SAS2 may be able to directly interface with the FCC databases to access information for SAS operations.

The domain proxy may be considered a management intermediary. Some of functionalities of the domain proxy may include, for example: accepting a set of one or more available channels and selecting a channel for use by a particular CBSD, or passing available channels to a carrier Element Management System (EMS) for CBSD channel selection; reporting the selected channel back to the SAS, which receives the selected channel optionally via the EMS; receiving a channel assignment confirmation from the SAS; performing bidirectional bulk CBSD registration and command processing optionally via the carrier EMS (if present); performing bi-directional information processing and routing; and performing other activities such as, for example, interference reporting or the like. The domain proxy may be optionally connected to the EMS, and the domain proxy may be co-located with the EMS.

The EMS can be connected to multiple CBSDs, such as CBSD1, CBSD2, CBSD3, and the like. Each CBSD domain may optionally include some sensing capability systems (e.g., CBSD sensing).

Currently, the FCC requires that CBRS operators employ transmission devices for use in the 3.5 GHz band with specific standardization capabilities. Such device is called a CBSD. The CBSDs are typically fixed base stations/wireless access points such as gNBs of the New Radio (NR), eNodeBs of the LTE, and the like. There are two categories of CBSDs: the first is low-power CBSDs of Category A, typically with an Equivalent Isotropic Radiated Power (EIRP) of 30 dBm/10 MHz, and with fixed indoor or outdoor locations; the second is high-power CBSDs of Category B, typically with an EIRP of 47 dBm, and with only fixed outdoor locations. The CBSDs may be registered with the SAS for utilizing the CBRS spectrum under authorization of the SAS.

End User Devices (EUDs) of the CBRS may be controlled by an authorized CBSD. The EUD may be capable to receive and decode information from the CBSD. An end user may access the communication network through one or more CBSDs and may use resources within a shared frequency band when the CBSD is granted a permission from the SAS.

The CBRS is applicable in many fields and has a greater potential to be explored. The most attractive point is construction of a private LTE network. While Wi-Fi technology has advantages such as relatively free rules, easy acquisition of devices, low cost, easy development and the like, it also has significant drawbacks compared to commercial LTE wireless networks. In contrast, the CBRS allows large companies to customize applications on employee mobile devices, creating a secure dedicated LTE network instead of the Wi-Fi to run enterprise-level or site-specific applications. The CBRS can also be used to provide in-building full coverage for various facilities by means of private networks with specific customized functionality (e . . . , enhanced security designs). In short, the CBRS enables private LTE networking independent of wireless operators, and has low cost and low complexity.

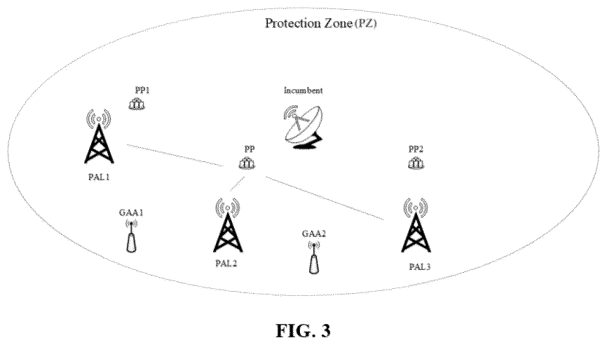

FIG. 3 illustrates an exemplary scenario of the CBRS system. As shown in the figure, within a Protection Zone (PZ) of an incumbent user, there may be several PAL users, such as PAL1, PAL2, and PAL3, and several GAA users, such as GAA1, and GAA2. In the context of the present disclosure, each of “PAL user” and “GAA user” refers to a registered entity that has operational responsibility for its CBSD, such as an operator of wireless access points, an administrator of a private LTE network, a WIFI hotspot provider, and the like. However, without ambiguity, the “PAL user” and its CBSD, the “GAA user” and its CBSD, the “incumbent user” and its device may be used interchangeably in the present disclosure.

To protect an incumbent user, Protection Points (PPs), such as PP, PP1, and PP2 in FIG. 3, will be set at particular locations within its protection zone. A sensor network is deployed at the protection point near the incumbent user's transmission device to detect activities at relevant frequencies. When interference occurs, the sensor may inform the Spectrum Access System (SAS), which instructs a potentially interfering device to change its channels. Furthermore, when a GAA user wishes to use the spectrum, it needs to request authorization from the SAS which evaluates an aggregate interference at the protection points and authorizes the GAA user to access the spectrum only if the evaluated aggregate interference does not exceed a permissible threshold.

However, such a conventional authorization framework basically relies on the centralized SAS to undertake management responsibilities, and the SAS is overloaded and is prone to single point of failure. In addition, there is room for further optimization of the management of the threshold of interferences experienced by the incumbent users, so as to allow more GAA users to have access to the CBRS spectrum.

In view of these, the present disclosure proposes an interference margin allocation mechanism mainly relying on the PAL users, that is, an interference margin available to a GAA user is proposed by the PAL user(s), and is reported to the SAS for authorization upon agreement of the GAA user. The interference margin allocation mechanism remains compatible with the existing system framework, and meanwhile, the interference margin for the incumbent users can be flexibly allocated as a resource, which is beneficial to improve utilization of the spectrum.

Various embodiments of the present disclosure will be described in detail below with reference to the accompanying figures.

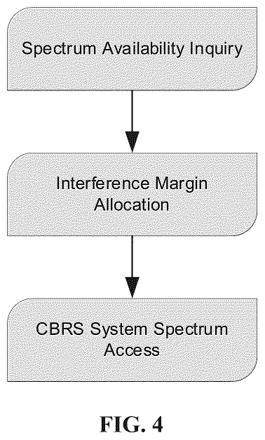

FIG. 4 conceptually illustrates a CBRS spectrum access method based on the interference margin allocation mechanism according to the present disclosure. As shown in the figure, for convenience of explanation, the spectrum access method according to embodiments of the present disclosure may be generally divided into spectrum availability inquiry, interference margin allocation, and CBRS system spectrum access. It should be understood, however, that this is merely a rough division and there may be additional steps.

### Spectrum Availability Inquiry

According to embodiments of the present disclosure, a GAA user wishing to access the system spectrum may inquire a PAL user (hereinafter referred to as “first PAL user” for purposes of differentiation) for current usage of the 3.5 GHz spectrum. There are a number of ways to determine the first PAL user that is inquired, for example at least one of the following factors may be considered: the first PAL user is geographically closest to the GAA user; the first PAL user has business contacts with the GAA user; the first PAL user is associated with a coexistence group (CxG) in which the GAA user is located or a coexistence manager (CxM) that manages the GAA user; the first PAL user is associated with a domain proxy serving the GAA user. Moreover, the first PAL user may be randomly selected by the GAA user from a plurality of neighboring PAL users. The PAL user providing the inquiry service to GAA users may be fixed or may change each time. The first PAL user providing the inquiry service to the GAA user corresponds to an anchor point for the GAA user to communicate with PAL users.

Current usage of the entire spectrum (e.g., the 3550-3700 MHz band) may be maintained at the first PAL user, including but not limited to: information on whether each of the frequency bands is being used or not, information on registered users on each of the frequency bands, information on aggregate interference on each of the frequency bands, information on transmission power of each user (for example, the GAA user to be described later) on each of the frequency bands, and the like.

To obtain the up-to-date spectrum usage information, each PAL user may periodically send an inquiry request to the SAS, which in response returns the current usage of the spectrum to the PAL user so that the PAL user may store or update the spectrum usage information in its database. Additionally or alternatively, the SAS may push the up-to-date spectrum usage information to each PAL user or even to each registered GAA user while updating its own database, based on information retrieved from an external database (e.g., ESC sensing results). In response to the inquiry request or proactively, the SAS may send the usage information of the entire spectrum (i.e., so-called full updating) or may send only change information compared to the last update (i.e., so-called incremental updating) to the PAL user.

According to one embodiment of the present disclosure, blockchain technique may be applied among PAL users within an authorization area (e.g., a census zone). For multiple PAL users in such an area, a blockchain may be constructed with PAL users as nodes, each of which maintains its own ledger. A distributed ledger is a database that is maintained and updated independently by each participant (or node) in the blockchain. Records are not delivered to the nodes by a central authority, but are constructed and maintained independently by each of the nodes. That is, each of the nodes on the network processes each transaction, reaches its own conclusions, and then votes on the conclusions to ensure that these conclusions are agreed by the majority. The PAL user nodes may pack transaction information into a block to be placed in the blockchain, and other PAL user nodes receive the block and verify the transaction in the block. After reaching a consensus, all nodes update the distributed ledger, and maintain their own copies of the same ledger.

When the PAL user receives the spectrum usage information from the SAS, it may synchronize this information in its local ledger. If the information is inconsistent with that in the local ledger, it is subject to the spectrum usage information provided by the SAS. Meanwhile, the spectrum usage information received from the SAS may be packed into a block and added to the blockchain by the PAL user, so that other PAL user nodes can share this information.

With the blockchain technology, the information sharing among the PAL user nodes is safer and more efficient. Timeliness and consistency of various information (e.g., the spectrum usage information) at the PAL user nodes may be further improved. However, it should be understood that it is preferable, but not necessary, to establish a blockchain for the PAL users. The information sharing may also be achieved through traditional interactions between the PAL users.

When a GAA user wants to access the CBRS system spectrum, it may need to obtain information about which of the frequency bands is available, and thus may send a spectrum availability inquiry request to an associated PAL user (i.e., the first PAL user). The inquiry request may include a frequency range to be inquired for, a CBSD identifier (CBSD ID) of the GAA user, an identifier (CxG ID) of the affiliated CxG, geographic location information, transmit power information, and so on. In one example, the GAA user may inquire for availability information for a particular frequency band or bands, while in another example, the GAA user may inquire for availability information for the entire 150 MHz spectrum.

In response to this inquiry request, the first PAL user may retrieve the usage of the 3.5 GHz spectrum in its database and return a response containing spectrum availability information to the GAA user based on a result of the retrieval.

In a case where the GAA user inquires for one or more specific frequency bands, the first PAL user may feed back to the GAA user information regarding whether each of these frequency bands is available or not, respectively. In the context of the present disclosure, a frequency band being “available” may mean that the frequency band currently is idle or otherwise available, e.g., the GAA user may share the frequency band with other users without causing harmful interference to incumbent users.

In a case where the GAA user inquires for the entire spectrum, the first PAL user may return a corresponding response to the GAA user based on the current usage information for each of the frequency bands maintained in its database. For example, if there are one or more frequency bands available, the response returned to the GAA user may indicate the one or more available frequency bands. Conversely, if there is no available frequency band, a frequency band sharing scheme (such as an interference margin allocation scheme to be described in detail below) may be proposed to the GAA user for selection by the GAA user, or a temporary absence of frequency bands for access may be indicated to the GAA user.

When the GAA user finds that there is currently an available frequency band, it can directly initiate a spectrum access procedure. For example, the GAA user may send a Grant request to the SAS (directly, or through a domain proxy), including a CBSD ID, a CxG ID, geographic location information, maximum transmit power information and the like in the request. The SAS determines whether the Grant request is approved or not according to the information provided by the GAA user, and if yes, authorizes the associated frequency band to the GAA user, otherwise refuses to authorize.

In particular, when there is no frequency band available currently, the interference margin allocation mechanism according to the present disclosure may be considered. In this case, the GAA user may receive at least one interference margin allocation scheme from the first PAL user as a response to the spectrum availability inquiry, as described below. In the worst case, there may be not available non-PAL bands, nor PAL users are willing to share their bands with the GAA user, and then the GAA user may be temporarily unable to use the CBRS spectrum.

### Interference Margin Allocation

The first PAL user may consider the interference margin allocation mechanism when the spectrum usage data retrieved by the first PAL user indicates that there are no available frequency bands.

According to embodiments of the present disclosure, instead of the SAS, the PAL user shares a frequency band with the GAA user according to its own frequency band usage, although the sharing is not like to be free. To avoid harmful interference to the incumbent users resulted from the transmission behavior of the GAA user, the PAL user may need to adjust its operational parameters, e.g., reduce the transmit power, so that the interference margin meets a transmit power demand of the GAA user. As used in the present disclosure, “interference margin” refers to a difference (or margin) between an aggregate interference of all current CBSDs to protection points within an incumbent user's protection zone and an interference threshold. For example, assuming that the interference threshold for the protection points is-80 dBm, and the aggregate interference to the protection points is reduced to −90 dBm after the transmission power adjustment of the PAL user, then the difference between the two is the interference margin for the protection points, which can be used by the GAA user. The maximum transmit power of the GAA user can be calculated from the interference margin (converted to power) and path losses to the protection points.

Such mechanism of the present disclosure (hereinafter referred to as interference margin allocation mechanism) takes into account the willingness of the PAL users, allowing them to utilize their frequency band resources more fully, and also allowing more GAA users to access the spectrum, while no harmful interference is caused to the incumbent users.

Various implementations of the interference margin allocation mechanism are possible. It can be appreciated that an essence of the interference margin allocation according to the present disclosure is flexible utilization of the interference margin by one or more PAL users, so that interference margin can be traded as a resource to the GAA users in demand. Three exemplary implementations will be mainly described below. However, it should be understood that there may be other implementations than those presented herein, which may fall within the scope of the present disclosure.

As a first example, the first PAL user estimates, based on its own business needs, whether it is possible to share its licensed band to the GAA user. For example, based on information such as geographic location information, maximum transmission power and the like of the GAA user provided by the GAA user in the spectrum availability inquiry request, the first PAL user may determine: whether co-channel interference is caused to the first PAL user and its end users if the GAA user also operates in the same frequency band. Optionally, the first PAL user further determines whether the interference margin in its frequency band can satisfy the transmit power of the GAA user, and then whether it needs to reduce its own transmit power. In addition, the first PAL user may also consider other factors, such as economic returns of the shared band, commercial impact, and so on. Assuming that the first PAL user determines to share its frequency band, an interference margin allocation scheme may be proposed, which includes an associated frequency band, an interference margin that can be provided, and optionally other information (e.g., quotation information).

The first PAL user may request the SAS to verify feasibility of the interference margin allocation scheme. The first PAL user may send to the SAS a feasibility inquiry request containing specific information of the interference margin allocation scheme, as well as geographic location information and transmit power information provided by the GAA user. The SAS determines whether the scheme will cause harmful interference to an incumbent user based on an aggregate interference received by various protection points (e.g., protection points PP, PP1, and PP2 in FIG. 3) within the incumbent user's protection zone and an estimated value of interference of the GAA user to the protection point PPs (estimated from the maximum transmit power of the GAA user and the path losses). If the interference margin allocation scheme is feasible, the SAS may return to the first PAL user a piece of information that the scheme is feasible, otherwise, return a piece of information that the scheme is infeasible. Additionally, the SAS may also set a scheme ID for the feasible interference margin allocation scheme and return this scheme ID to the first PAL user. The first PAL user may forward to the GAA user the interference margin scheme that has been verified as being feasible by the SAS, as well as the scheme ID.

As a second example, the first PAL user may broadcast contents of the spectrum availability information inquiry request (including the inquired frequency band range, geographical location information, transmit power information, and the like) sent by the GAA user to one or more other PAL users, such as other PAL user nodes on the blockchain.

Each of the PAL users, including the first PAL user, independently determines whether it would like to share its licensed band with the GAA user. As described above, the PAL users may consider various factors. Assuming that one or more PAL users other than the first PAL user (collectively referred to as “second PAL users”) determine to share their frequency bands, respective interference margin allocation schemes may be sent to the first PAL user within a specified time, the interference margin allocation scheme including an associated frequency band, an interference margin that can be provided, and optionally other information (e.g., quotation information). Of course, the first PAL user may also propose its own interference margin allocation scheme.

The first PAL user may request the SAS to verify feasibility of all interference margin allocation schemes that are collected. The first PAL user may send to the SAS a feasibility inquiry request containing, for example, specific information of each of the interference margin allocation schemes, as well as the geographic location information and transmit power information provided by the GAA user. The SAS determines whether each of the schemes will cause harmful interference to an incumbent user based on an aggregate interference received by various protection points (e.g., protection points PP, PP1, and PP2 in FIG. 3) within the incumbent user's protection zone and an estimated value of interference of the GAA user to the protection points PPs (estimated from the maximum transmit power of the GAA user and the path losses). If an interference margin allocation scheme is feasible, the SAS may return to the first PAL user a piece of information that the scheme is feasible, otherwise, return a piece of information that the scheme is infeasible. Additionally, the SAS may also set a scheme ID for the feasible interference margin allocation scheme and return this scheme ID to the first PAL user. The first PAL user may forward to the GAA user one or more interference margin schemes that have been verified as being feasible by the SAS, as well as corresponding scheme IDs.

As a third example, the first PAL user may broadcast contents of a spectrum availability information inquiry request sent by a GAA user (including the inquired frequency band range, the geographical location information, the transmit power information, and the like.) to one or more other PAL users, such as other PAL user nodes on the blockchain.

Each of the PAL users, including the first PAL user, may determine whether it would like to provide a frequency band and an interference margin to the GAA user in cooperation. The PAL users willing to participate in the cooperation (the second PAL user) may send information that they agree to participate in the cooperation to the first PAL user within a specified time. In general, the PAL users participating in the cooperation may be all or a part of the PAL users associated with the frequency band as inquired by the GAA user. In the present disclosure, “cooperation” may have various implementations depending on pre-agreed agreements between the PAL users. For example, two or more PAL users participating in the cooperation may provide interference margins equally to meet the transmit power requirement of the GAA user. As another example, the PAL users participating in the cooperation may provide interference margins proportionally. As yet another example, the PAL users participating in the cooperation may provide interference margins that are otherwise determined, as long as the transmit power demand of the GAA user is met. The interference margins shared by the PAL users may constitute a smart contract as a basis of subsequent payments of the GAA user. The PAL users that do not participate in the cooperation may take no action.

The first PAL user arranges a list of the collected PAL users participating in the cooperation, the interference margins and the associated frequency bands provided by them into an interference margin allocation scheme. The first PAL user may request the SAS to verify feasibility of the interference margin allocation scheme. The first PAL user may send to the SAS a feasibility inquiry request containing, for example, specific information of the interference margin allocation scheme, as well as the geographic location information and transmit power information provided by the GAA user. The SAS determines whether the scheme will cause harmful interference to an incumbent user based on an aggregate interference received by various protection points (e.g., the protection points PP, PP1, and PP2 in FIG. 3) within the incumbent user's protection zone and an estimated value of interference of the GAA user to the protection points PPs. If the interference margin allocation scheme is feasible, the SAS may return to the first PAL user a piece of information that the scheme is feasible, otherwise, return a piece of information that the scheme is infeasible. Additionally, the SAS may also set a scheme ID for the feasible interference margin allocation scheme and return this scheme ID to the first PAL user. The first PAL user may forward to the GAA user the interference margin allocation scheme that has been verified as being feasible by the SAS, as well as the scheme ID.

### CBRS System Spectrum Access

The GAA user may initiate a spectrum access procedure using an accepted interference margin allocation scheme. The CBRS spectrum access procedure according to the present disclosure may be compatible with existing CBRS spectrum authorization procedures with minor modifications to message formats and/or flows, and therefore, steps closely related to the present disclosure will be described briefly herein, with reference to an existing standard protocol for remaining details, such as TS-0016 published by Wireless Innovation Forum (WINNF), which is incorporated herein by reference in its entirety.

First, the GAA user sends a spectrum inquiry request (spectrumInquiryRequest) message to the SAS, e.g., directly or via a domain proxy. The spectrum inquiry request message contains at least an ID of the interference margin allocation scheme accepted by the GAA user. If the GAA user receives a plurality of interference margin allocation schemes from the first PAL user, it may make a comparison and select the most suitable one.

The spectrum inquiry request message is composed of an array of objects SpectrumInquiryRequest, each of which represents a spectrum inquiry request for one CBSD and may include the following parameters:
an identifier of the CBSD (cbsdId), which needs to be set by the CBSD to its CBSD identity value;
inquirySpectrum indicating a frequency band for which the CBSD wishes to inquire the spectrum availability, consisting of an array of objects FrequencyRange, each of which including a lowest frequency and a highest frequency representing a frequency band;
measReport, which is a conditional parameter and is composed of objects MeasReport set when the CBSD reports measurements to the SAS using the parameter;
interference margin allocation scheme ID, which is a field newly added according to the present disclosure to indicate the interference margin scheme that the GAA user wishes to inquire and implement.

Upon receiving the spectrum inquiry request, the SAS finds the associated interference margin allocation scheme by means of the scheme ID contained therein. The PAL user associated with the interference margin allocation scheme periodically sends a heartbeat request to the SAS. In a heartbeat response for that PAL user, the SAS may instruct the PAL user to adjust operational parameters, for example, to reduce the transmit power, according to the interference margin allocation scheme proposed by it.

For example, if the GAA user chooses to accept the interference margin allocation scheme proposed by the first PAL user, the SAS may inform the first PAL user of this fact in the heartbeat response, thereby the first PAL user concludes a transaction with the GAA user with respect to the frequency band sharing and interference margin, and releases, by reducing its transmit power, the proposed frequency band and interference margin resources for use by the GAA user.

Similarly, if the GAA user chooses to accept an interference margin allocation scheme proposed by a second PAL user that is not the first PAL user, the SAS may instruct to adjust the operational parameters in the heartbeat response to the second PAL user.

If the GAA user chooses to accept an interference margin allocation scheme proposed cooperatively by multiple PAL users, the SAS may notify this fact in the heartbeat responses to these PAL users, respectively, or in the heartbeat response to the first PAL user, and the first PAL user triggers a smart contract corresponding to the interference margin allocation scheme. The PAL users participating in the cooperation fulfill their obligations according to the smart contract by adjusting the operational parameters, e.g., reducing the transmission power.

On the other hand, in response to the spectrum inquiry request from the GAA user, the SAS may return a spectrum inquiry response message to the GAA user to indicate that the frequency band inquired by the GAA user is available.

The GAA user then sends a Grant request message to the SAS to request use of the above frequency band. The Grant request message is composed of an array of objects GrantRequest, wherein each GrantRequest object represents an authorization request for one CBSD and may include the following parameters:
an identifier of the CBSD (cbsdId), which needs to be set by the CBSD to its CBSD identity value;
operationParam, which is composed of objects OperationParam and includes operational parameters that are requested for authorization, such as maximum Equivalent Isotropic Radiated Power (EIRP) and operational frequency range;
measReport, which is a conditional parameter and is composed of objects MeasReport, and is set when the CBSD reports measurements to the SAS using this parameter.

The SAS determines whether to approve the Grant request or not according to the Grant request provided by the GAA user. If yes, the corresponding frequency band is allocated to the GAA user. Therefore, the GAA user can access the CBRS spectrum and provide communication services by using the authorized frequency band.

The GAA user may inform the first PAL user and/or the second PAL user that proposed the interference margin allocation scheme of a result of the spectrum access procedure, and the first PAL user and the second PAL user may be the same or different, as described above. In addition, the GAA user may pay corresponding fees to the involved PAL users, e.g., pay fees to the first PAL user for the spectrum availability inquiry service, the service for coordinating and forwarding the interference margin allocation scheme, the service for inquiring feasibility of the interference margin allocation scheme and the like provided by the first PAL user; for the first or second PAL user that proposed the interference margin allocation scheme accepted by the GAA user, the GAA user may pay for the occupied frequency band and interference margin.

In embodiments where the PAL users form a blockchain, the first PAL user or the second PAL user may pack the spectrum usage information of the GAA user into a block that is broadcast to all PAL user nodes on the chain so that each of the PAL users updates its spectrum usage information database. The remaining PAL user nodes verify identities of the traders using a Member Service Provider (MSP) and verify validity of the block using a hash algorithm of Merkle proof. After the PAL user nodes have verified the validity, the block is added to the blockchain, and all PAL user nodes update the frequency spectrum usage information to the local ledgers maintained by them.

Similarly, the first PAL user or the second PAL user may record the interference margin information and the payment transaction information in the block, and all PAL user nodes on the blockchain receive the block and add the block to the blockchain after verifying the transaction therein.

### Example Flowcharts

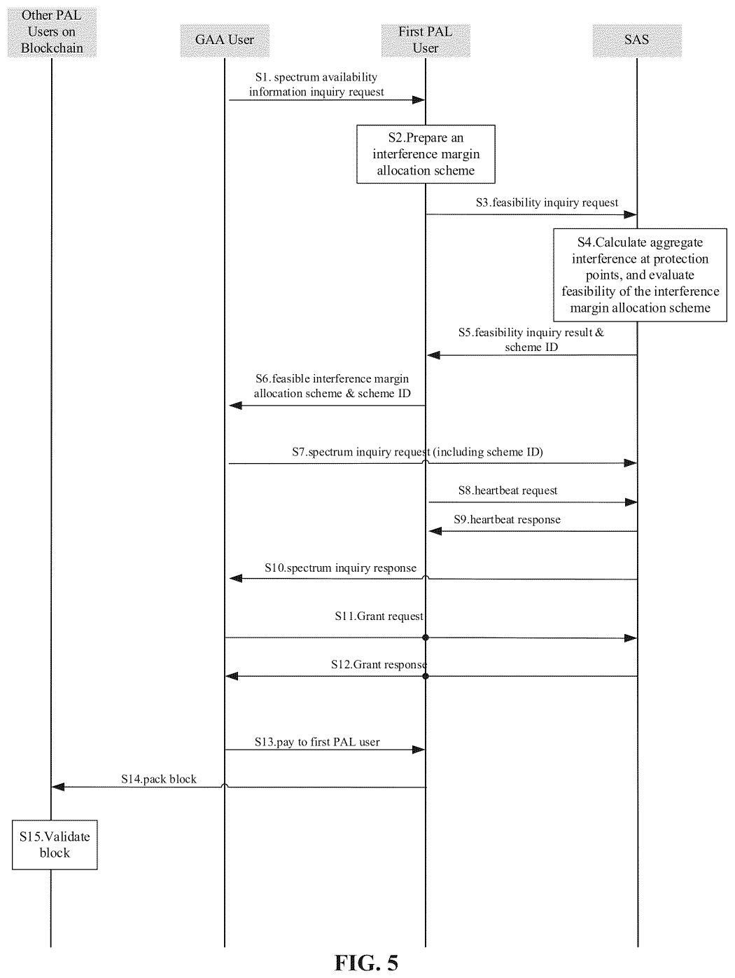

The CBRS spectrum access method according to the present disclosure, which utilizes the interference margin allocation mechanism dominated by the PAL users, is briefly introduced above. Example flowcharts according to the present disclosure will be described below in connection with FIGS. 5-7.

FIGS. 5-7 show exemplary embodiments where a blockchain is composed of PAL users as nodes, however it should be understood that this is not limiting and interactions between the PAL users may not rely on the blockchain technology.

As shown in FIG. 5, a flowchart according to an exemplary embodiment of the present disclosure includes:
in S1, a GAA user sends a spectrum availability information inquiry request to a first PAL user;
in S2, in response to the spectrum availability information inquiry request from the GAA user, the first PAL user retrieves spectrum availability information from its local database. When the spectrum availability information indicates that no available frequency bands are available, the first PAL user prepares an interference margin allocation scheme, which comprises at least a frequency band and an interference margin shared by the first PAL user;
in S3, the first PAL user sends a feasibility inquiry request regarding the interference margin allocation scheme to a SAS;
in S4, the SAS calculates an aggregate interference at various protection points, for example, by using a Monte Carlo method based on transmission parameters and location information of CBSDs, and evaluates feasibility of the interference margin allocation scheme. When the interference margin allocation scheme is feasible, the SAS may further set a scheme ID for it;
in S5, the SAS sends a feasibility inquiry result to the first PAL user along with the possible scheme ID;
in S6, the first PAL user sends the feasible interference margin allocation scheme and the scheme ID thereof to the GAA user as a response to the spectrum availability information inquiry request;
in S7, based on the interference margin allocation scheme, the GAA user sends a spectrum inquiry request to the SAS, the request containing at least the scheme ID received in S6;
in S8, the first PAL user periodically sends a heartbeat request to the SAS;
in S9, upon receiving the spectrum inquiry request from the GAA user in S7, the SAS informs the first PAL user in a heartbeat response that the GAA user requests implementation of the interference margin allocation scheme associated with the scheme ID, and the first PAL user adjusts the operational parameters, e.g., reduces its transmit power, according to the interference margin allocation scheme proposed by it;
in S10, the SAS returns a spectrum inquiry response to the spectrum inquiry request received in S7 to the GAA user, the spectrum inquiry response indicating that the frequency band inquired by the GAA user is available;
in S11, the GAA user sends a Grant request to the SAS to request use of the above frequency band. The GAA user can send the Grant request to the SAS via the first PAL user, or can send the Grant request directly to the SAS while sending contents of the request to the first PAL user;
in S12, the SAS returns a Grant response to the GAA user to authorize the use of the associated band. Wherein, the SAS may send the Grant response to the GAA user via the first PAL user, or may send the Grant response directly to the GAA user while sending contents of the response to the first PAL user. After receiving the response of successful authorization, the GAA user can utilize the CBRS frequency band to perform information transmission;
in S13, after successful access to the system spectrum, the GAA user informs the first PAL user and pays corresponding fees;
in S14, the first PAL user packs the transfer information and the interference margin transaction information into a block;
in S15, other PAL user nodes on the blockchain receive the block and verify the transaction in this block. The successfully verified block is placed in the blockchain.

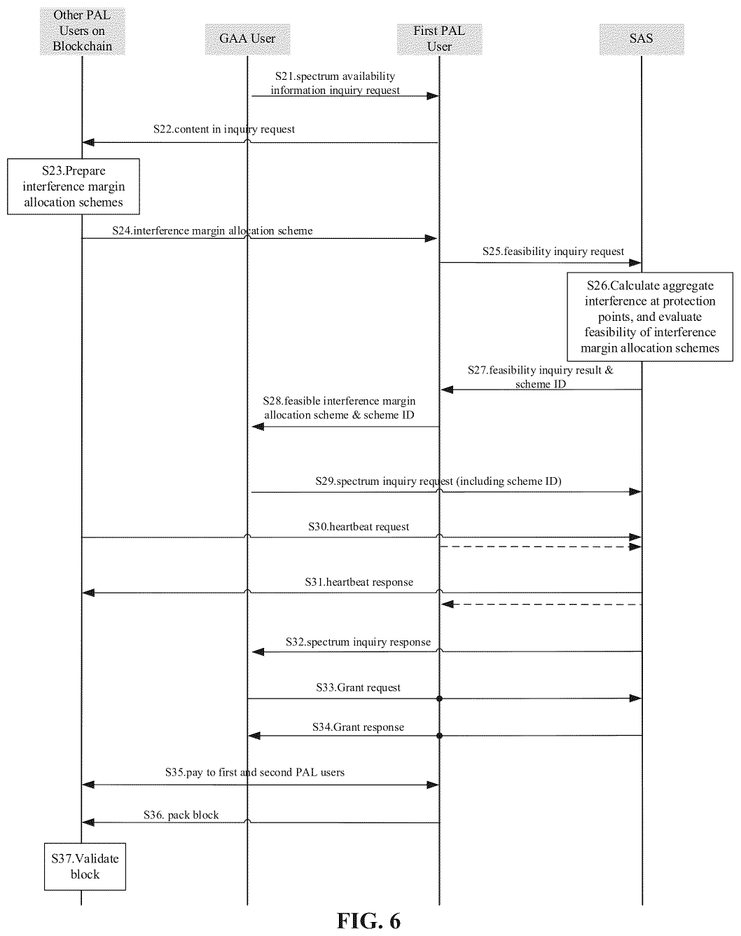

As shown in FIG. 6, a flowchart according to another exemplary embodiment of the present disclosure includes:
in S21, the GAA user sends a spectrum availability information inquiry request to the first PAL user;
in S22, in response to the spectrum availability information inquiry request from the GAA user, the first PAL user retrieves spectrum availability information from its local database. When the spectrum availability information indicates that no frequency bands are available, the first PAL user broadcasts contents of the inquiry request from the GAA user to other PAL users on the blockchain;
in S23, PAL user(s) willing to share a frequency band (second PAL user(s)) prepares an interference margin allocation scheme, where the scheme at least includes a frequency band and an interference margin shared by the second PAL user(s);
in S24, each of second PAL user(s) sends an interference margin allocation scheme to the first PAL user;
in S25, the first PAL user sends the interference margin allocation scheme(s) from the second PAL user(s) and a feasibility inquiry request to the SAS;
in S26, the SAS calculates an aggregate interference at various protection points, for example, by using a Monte Carlo method based on transmission parameters and location information of CBSDs, and evaluates feasibility of each interference margin allocation scheme. When the interference margin allocation scheme is feasible, the SAS may further set a scheme ID for it;
in S27, the SAS sends a feasibility inquiry result and a possible scheme ID to the first PAL user;
in S28, the first PAL user sends the feasible interference margin allocation scheme and the scheme ID thereof to the GAA user as a response to the spectrum availability information inquiry request;
at S29, based on the interference margin allocation scheme, the GAA user sends a spectrum inquiry request to the SAS, the request containing at least the scheme ID received in S28. If the GAA user receives more than one interference margin allocation scheme in S28, one of them may be selected;
in S30, the second PAL user(s) which proposed the interference margin allocation scheme associated with the scheme ID contained in the spectrum inquiry request periodically sends a heartbeat request to the SAS;
in S31, upon receiving the spectrum inquiry request from the GAA user in S29, the SAS informs the second PAL user(s) in a heartbeat response that the GAA user requests implementation of the interference margin allocation scheme associated with the scheme ID. The second PAL user(s) adjusts the operational parameters, e.g., reduces the transmit power, according to the interference margin allocation scheme proposed by it or them;
A case is assumed above that the GAA user selects an interference margin allocation scheme proposed by a second PAL user other than the first PAL user. However, the GAA user may also select an interference margin allocation scheme proposed by the first PAL user, and in this case the first PAL user sends a heartbeat request to the SAS in S30, receives a heartbeat response from the SAS in S31, and adjusts operational parameters based on the heartbeat response, as indicated by dashed lines in FIG. 6.

In S32, the SAS returns a spectrum inquiry response to the spectrum inquiry request received in S30 to the GAA user, the spectrum inquiry response indicating that the frequency band inquired by the GAA user is available;
in S33, the GAA user sends a Grant request to the SAS to request use of the above frequency band. The GAA user can send the Grant request to the SAS via the first PAL user, or can send the Grant request directly to the SAS while sending contents of the request to the first PAL user;
in S34, the SAS returns a Grant response to the GAA user to authorize use of the associated band. Wherein, the SAS may send the Grant response to the GAA user via the first PAL user, or may send the Grant response directly to the GAA user while sending contents of the response to the first PAL user. After receiving the response of successful authorization, the GAA user can utilize the CBRS frequency band to perform information transmission;
in S35, after successful access to the system spectrum, the GAA user informs the first PAL user and the second PAL user, and pays corresponding fees;
at S36, the first PAL user packs the transfer information and the interference margin transaction information into a block;
in S37, other PAL user nodes on the blockchain receive the block and verify the transaction in this block. The successfully verified block is placed in the blockchain.

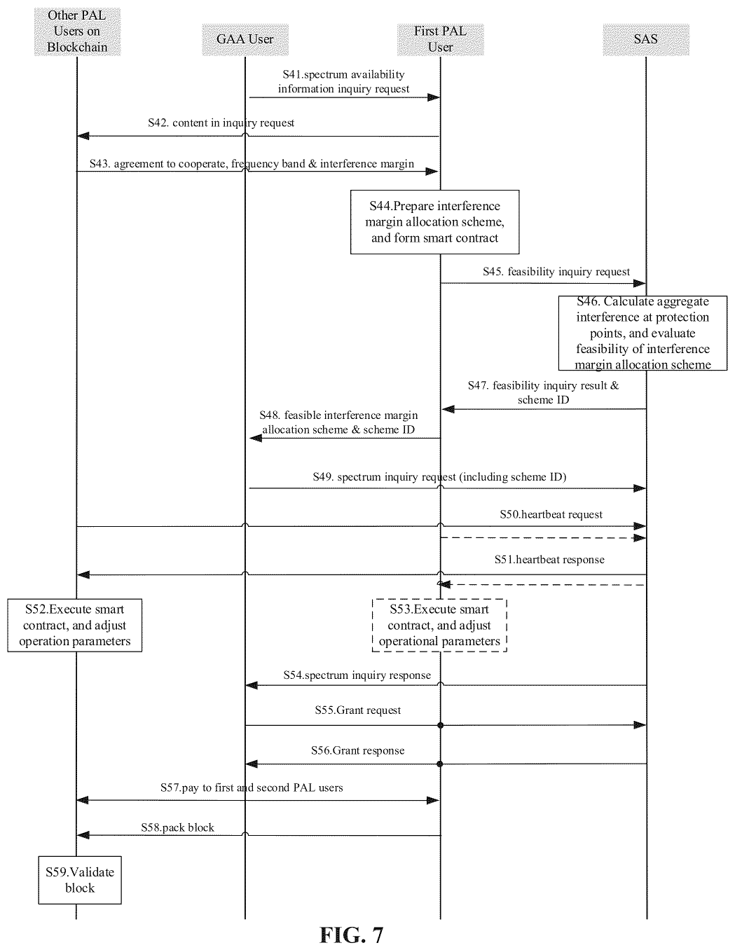

As shown in FIG. 7, a flowchart according to yet another exemplary embodiment of the present disclosure includes:
in S41, the GAA user sends a spectrum availability information inquiry request to the first PAL user;
in S42, in response to the spectrum availability information inquiry request from the GAA user, the first PAL user retrieves spectrum availability from its local data information and returns it to the GAA user. Furthermore, when the spectrum availability information indicates that no frequency bands are available, the first PAL user broadcasts contents of the GAA user inquiry to other PAL users on the blockchain;
in S43, the PAL user(s) willing to share the frequency band (the second PAL user(s)) informs the first PAL user of agreeing to participate in the cooperation;
in S44, the first PAL user(s) prepares an interference margin allocation scheme, which includes at least a frequency band and an interference margin shared by respective PAL user. The first PAL user further forms a smart contract corresponding to the interference margin allocation scheme, in which a contribution share of each second PAL user in the interference margin is specified;
in S45, the first PAL user sends a feasibility inquiry request regarding the interference margin allocation scheme to the SAS;
in S46, the SAS calculates an aggregate interference at various protection points, for example, by using a Monte Carlo method based on transmission parameters and location information of CBSDs, and evaluates feasibility of the interference margin allocation scheme. When the interference margin allocation scheme is feasible, the SAS may further set a scheme ID for it;
in S47, the SAS sends a feasibility inquiry result and a possible scheme ID to the first PAL user;
in S48, the first PAL user sends the feasible interference margin allocation scheme and the scheme ID thereof to the GAA user as a response to the spectrum availability information inquiry request;
in S49, based on the interference margin allocation scheme, the GAA user sends a spectrum inquiry request to the SAS, the request containing at least the scheme ID received in S48;
in S50, all second PAL users participating in the cooperation periodically send heartbeat requests to the SAS, as indicated by the dashed line, and if the first PAL user is also participating in providing the interference margin, S50 further includes the first PAL user sending a heartbeat request;
in S51, upon receiving the spectrum inquiry request from the GAA user in S49, the SAS informs all second PAL users in heartbeat responses that the GAA user requests implementation of the interference margin allocation scheme associated with the scheme ID (optionally, the first PAL user may also be informed if it is also participating in the cooperation, as indicated by a dashed line);
in S52, each second PAL user participating in the cooperation is triggered to execute a smart contract corresponding to the interference margin allocation scheme, and adjusts its operational parameters, for example, reduces the transmission power;
optionally, in S53, the first PAL user participating in the cooperation also executes a smart contract, and adjusts its operational parameters, such as reduces the transmission power;
in S54, the SAS returns a spectrum inquiry response to the spectrum inquiry request received in S49 to the GAA user, the spectrum inquiry response indicating that the frequency band inquired by the GAA user is available;
in S55, the GAA user sends a Grant request to the SAS to request use of the above frequency band. The GAA user may send the Grant request to the SAS via the first PAL user, or may send the Grant request directly to the SAS while sending contents of the request to the first PAL user;
in S56, the SAS returns a Grant response to the GAA user to authorize use of the associated frequency band. Wherein, the SAS may send the Grant response to the GAA user via the first PAL user, or may send the Grant response directly to the GAA user while sending contents of the response to the first PAL user. After receiving the response of successful authorization, the GAA user can utilize the CBRS frequency band to perform information transmission;
in S57, after successful access to the system spectrum, the GAA user informs the first PAL user and the PAL users participating in the cooperation (all second PAL users), and pays corresponding fees;
in S58, the first PAL user packs the transfer information and the interference margin transaction information into a block;
in S59, other PAL user nodes on the blockchain receive the block and verify the transaction in this block. The successfully verified block is placed in the blockchain.

### Simulation

The inventors verified the performance of the spectrum access method according to the present disclosure by simulation.

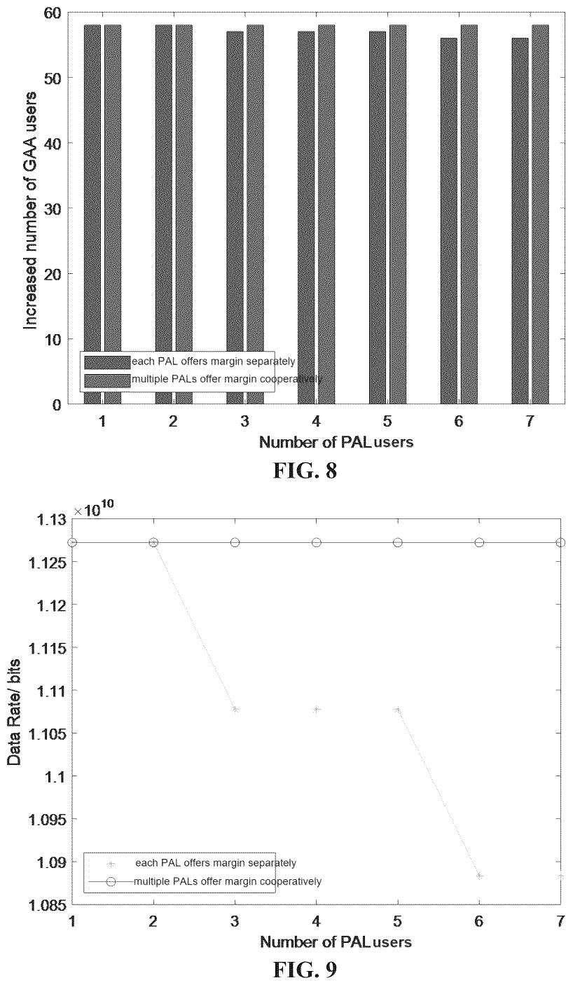

In this simulation, the range of the interference thresholds required by the GAA users is set to 1e-8 mW to 1e-7 mW and subject to uniform distribution, and the transmission power of the GAA user is set to 10 mW. The interferences of PAL users to incumbent users are artificially set to different proportions. In addition, when multiple PAL users cooperate to provide an interference margin as in the third example of the interference margin allocation described above, the multiple PAL users provide corresponding interference margins to the GAA user by a set ratio, which is marked as “multiple PALs offer margin cooperatively” in FIGS. 8 and 9; for the first and second examples of the interference margin allocation, the interference margin is provided by a single PAL user, so that the schemes are not distinguished in the simulation, and both are marked as “each PAL offers margin separately” in FIGS. 8 and 9.

As shown in FIG. 8, by comparing the schemes of “each PAL offers margin separately” and “multiple PALs offer margin cooperatively”, when the number of PAL users is small, the number of GAA users that can be increased is the same, and as the number of PAL users increases, the number of GAA users that can access by using the method of multiple PALs offering interference margin cooperatively is higher than the scheme of each PAL user offering interference margin separately. It can be shown that the method for offering the interference margin by cooperation of multiple PAL users can utilize the interference margin more fully.

FIG. 9 shows system throughput values that can be increased with respect to different numbers of PAL users, respectively. If the scheme of each PAL user offering the interference margin separately is adopted, an increase value of the system throughput is reduced as the PAL users increase, and the increase value of the system throughput is not changed in the case of multiple PAL users offering the interference margin cooperatively. The reason is that when each PAL user offers an interference margin scheme separately, the GAA user cannot fully utilize the margins, and there are residual interference margins. This also shows that when the number of PAL users increases, the interference margins provided by the PAL users can be more fully utilized, and more GAA users can access, so that the increase value of the system throughput will not be reduced.

### Electronic Device and Communication Method

Electronic devices and communication methods in which various embodiments of the present disclosure can be implemented are described below in connection with figures.

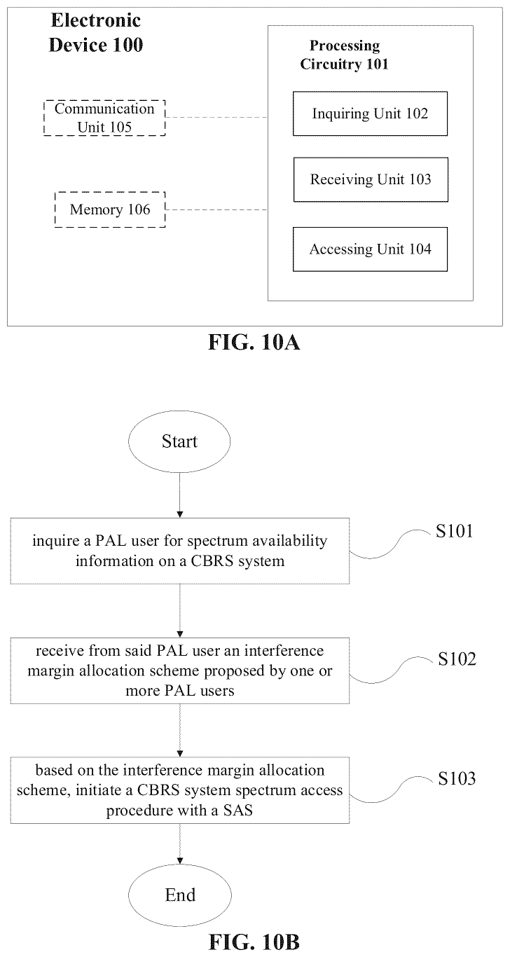

FIG. 10A is a block diagram illustrating an electronic device 100 for a GAA user according to the present disclosure, and FIG. 10B illustrates a flowchart of a communication method that can be performed by the electronic device 100. The electronic device 100 may be a CBSD of the GAA user or a component thereof.

As shown in FIG. 10A, the electronic device 100 comprises processing circuitry 101. The processing circuitry 101 includes at least an inquiring unit 102, a receiving unit 103, and an accessing unit 104. The processing circuitry 101 may be configured to perform the communication method as shown in FIG. 10B. The processing circuitry 101 may refer to various implementations of digital, analog, or mixed-signal (a combination of analog signal and digital signal) circuitry for performing functions in a computing system. The processing circuitry may include, for example, circuitry such as an integrated circuit (IC) or an application specific integrated circuit (ASIC), portions or circuits of an individual processor core, an entire processor core, an individual processor, a programmable hardware device such as a field programmable gate array (FPGA), and/or a system including multiple processors.

The inquiring unit 102 in the processing circuitry 101 is configured to inquire a PAL user (e.g., the first PAL user as described above) for spectrum availability information on a CBRS system, that is, to perform step S101 in FIG. 10B. The inquiring unit 102 may perform the inquiry by sending a spectrum availability information query request, wherein the inquiry request may include a CSBD ID, geographical location information, maximum transmission power information, and a CxG ID of the GAA user, and the like. The PAL user returns the spectrum availability information to the inquiring unit 102 as a response.

The receiving unit 103 is configured to receive an interference margin allocation scheme proposed by one or more PAL users from the PAL user, that is, to perform step S102 in FIG. 10B. Wherein, the receiving unit 104 may receive one interference margin allocation scheme proposed by the PAL user or another PAL user, or a plurality of interference margin allocation schemes proposed by a plurality of PAL users, respectively, or one interference margin allocation scheme cooperatively provided by a plurality of PAL users. In a case where the receiving unit 104 receives a plurality of interference margin allocation schemes, it may further make a selection therefrom and indicate the selected interference margin allocation scheme to the PAL user. The one or more PAL users may be nodes that form a blockchain.

The accessing unit 104 is configured to initiate a CBRS system spectrum access procedure with a SAS based on the interference margin allocation scheme, that is, to perform step S103 in FIG. 10B. The accessing unit 104 may obtain authorization for a frequency band from the SAS by sending a spectrum query request and a Grant request to the SAS.

The electronic device 100 may further comprise a communication unit 105 and a memory 106, for example.

The communication unit 105 can be configured to communicate with anther device (e.g., a CBSD of a PAL user, a SAS, and the like) under control of the processing circuitry 101. In one example, the communication unit 105 can be implemented as a transmitter or transceiver including communication components such as an antenna array and/or a radio frequency link. The communication unit 105 is depicted with a dashed line since it may also be located outside the electronic device 100.

The electronic device 100 may also include a memory 106. The memory 106 may store various data and instructions, such as programs and data for operation of the electronic device 100, various data generated by the processing circuitry 101, data received by the communication unit 105 and the like. The memory 106 may be a volatile memory and/or a non-volatile memory. For example, the memory 106 may include, but is not limited to, Random Access Memory (RAM), Dynamic Random Access Memory (DRAM), Static Random Access Memory (SRAM), Read Only Memory (ROM), or flash memory.

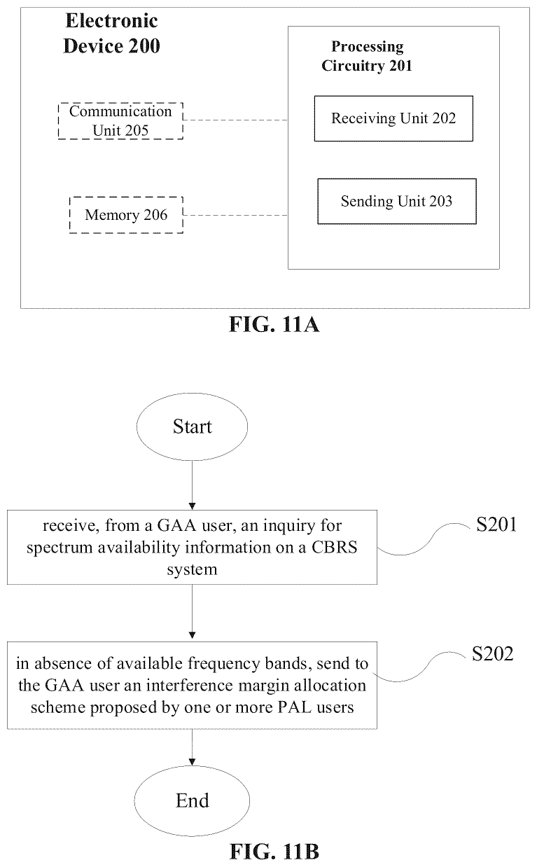

FIG. 11A is a block diagram illustrating an electronic device 200 for a PAL user according to the present disclosure. The electronic device 200 may be a CBSD of a PAL user (e.g., the first PAL user as described above) or a component thereof.

As shown in FIG. 11A, the electronic device 200 comprises processing circuitry 201. The processing circuitry 201 includes at least a receiving unit 202 and a sending unit 203. The processing circuitry 201 may be configured to perform a communication method as shown in FIG. 11B. The processing circuitry 201 may refer to various implementations of digital, analog, or mixed-signal (a combination of analog signal and digital signal) circuitry for performing functions in a computing system. The processing circuitry may include, for example, circuitry such as an integrated circuit (IC) or an application specific integrated circuit (ASIC), portions or circuits of an individual processor core, an entire processor core, an individual processor, a programmable hardware device such as a field programmable gate array (FPGA), and/or a system including multiple processors.

The receiving unit 202 of the processing circuitry 201 is configured to receive, from a GAA user, an inquiry for spectrum availability information on a CBRS system, that is, to perform step S201 in FIG. 11B. The inquiry request from the GAA user may include a CSBD ID, geographical location information, maximum transmission power information, and a CxG ID of the GAA user, and the like.

The sending unit 203 is configured to send an interference margin allocation scheme proposed by one or more PAL users to the GAA user in absence of available frequency band, that is, to perform step S202 in FIG. 11B. The one or more PAL users may be nodes that form a blockchain. Wherein the sending unit 203 may send one interference margin allocation scheme proposed by the PAL user or another PAL user, or a plurality of interference margin allocation schemes proposed by a plurality of PAL users, respectively, or one interference margin allocation scheme cooperatively provided by a plurality of PAL users.

The electronic device 200 may also include a memory 205 and a memory 206.

The communication unit 205 can be configured to communicate with another device (e.g., a CBSD of a GAA user, a CBSD of another PAL user, a SAS, and the like) under control of the processing circuitry 201. In one example, the communication unit 205 can be implemented as a transmitter or transceiver including communication components such as an antenna array and/or a radio frequency link. The communication unit 205 is depicted with a dashed line since it may also be located outside the electronic device 200.

The electronic device 200 may also include a memory 206. The memory 206 may store various data and instructions, such as programs and data for operation of the electronic device 200, various data generated by the processing circuitry 201, various control signaling or traffic data to be transmitted by the communication unit 205, and so forth. The memory 206 is depicted with a dashed line because it may also be located within the processing circuitry 201 or outside the electronic device 200. The memory 206 may be a volatile memory and/or a non-volatile memory. For example, the memory 206 may include, but is not limited to, Random Access Memory (RAM), Dynamic Random Access Memory (DRAM), Static Random Access Memory (SRAM), Read Only Memory (ROM), or flash memory.

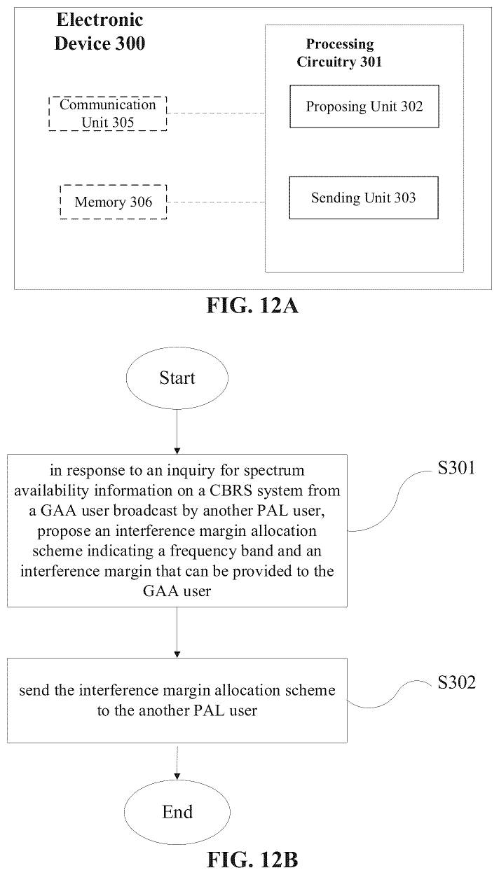

FIG. 12A is a block diagram illustrating an electronic device 300 for a PAL user according to the present disclosure. The electronic device 300 may be a CBSD of a PAL user (e.g., the second PAL user as described above) or a component thereof.

As shown in FIG. 12A, the electronic device 300 comprises processing circuitry 301. The processing circuitry 301 includes at least a proposing unit 302 and a sending unit 303. The processing circuitry 301 may be configured to perform a communication method as shown in FIG. 12B. The processing circuitry 301 may refer to various implementations of digital, analog, or mixed-signal (a combination of analog signal and digital signal) circuitry for performing functions in a computing system. The processing circuitry may include, for example, circuitry such as an integrated circuit (IC) or an application specific integrated circuit (ASIC), portions or circuits of an individual processor core, an entire processor core, an individual processor, a programmable hardware device such as a field programmable gate array (FPGA), and/or a system including multiple processors.

The proposing unit 302 of the processing circuitry 301 is configured to in response to an inquiry for spectrum availability information on a CBRS system from a GAA user broadcast by another PAL user, propose an interference margin allocation scheme indicating a frequency band and an interference margin that can be provided to the GAA user by the PAL user, that is, to perform step S301 in FIG. 12B.

The sending unit 303 is configured to send the interference margin allocation scheme to the another PAL user, that is, to perform step S302 in FIG. 12B. The interference margin allocation scheme may be provided by the PAL user independently, or provided by the PAL user participating in cooperation.

The electronic device 300 may also include a memory 305 and a memory 306.

The communication unit 305 can be configured to communicate with another device (e.g., a CBSD of a GAA user, a CBSD of another PAL user, a SAS, and the like) under control of the processing circuitry 301. In one example, the communication unit 305 can be implemented as a transmitter or transceiver including communication components such as an antenna array and/or a radio frequency link. The communication unit 305 is depicted with a dashed line since it may also be located outside the electronic device 300.

The electronic device 300 may also include a memory 306. The memory 306 may store various data and instructions, such as programs and data for operation of the electronic device 300, various data generated by the processing circuitry 301, various control signaling or traffic data to be transmitted by the communication unit 305, and so forth. The memory 306 is depicted with a dashed line because it may also be located within the processing circuitry 301 or outside the electronic device 300. The memory 306 may be a volatile memory and/or a non-volatile memory. For example, the memory 306 may include, but is not limited to, Random Access Memory (RAM), Dynamic Random Access Memory (DRAM), Static Random Access Memory (SRAM), Read Only Memory (ROM), or flash memory.

It should be understood that the units of the electronic devices 100, 200, and 300 described in the above embodiments are only logical modules divided according to the specific functions they implement, and are not used to limit specific implementations. In an actual implementation, the foregoing units may be implemented as individual physical entities, or may also be implemented by a single entity (for example, a processor (CPU or DSP, etc.), an integrated circuit, etc.).

Various aspects of the embodiments of the present disclosure have been described in detail above, but it will be appreciated that the communication devices, communication methods, signaling flows and the like are illustrated for purpose of description, and are not intended to limit the aspects of the present disclosure to these specific examples.

### Exemplary Implementations of the Present Disclosure

According to the embodiments of the present disclosure, various implementations for practicing concepts of the present disclosure can be conceived, including but not limited to:
1). An electronic device for a General Authorized Access (GAA) user, comprising:
processing circuitry configured to
   inquire a Priority Access License (PAL) user for spectrum availability information on a Citizen Broadband Radio Service (CBRS) system;
   in absence of available frequency bands, receive from said PAL user at least one interference margin allocation scheme proposed by one or more PAL users;
   based on a particular interference margin allocation scheme of the at least one interference margin allocation scheme, initiate a CBRS system spectrum access procedure with a Spectrum Access System (SAS).
2). The electronic device according to 1), wherein the at least one interference margin allocation scheme includes one of the following:
an interference margin allocation scheme proposed by said PAL user or another PAL user, indicating a frequency band and an interference margin provided by said PAL user or the another PAL user;
a plurality of interference margin allocation schemes proposed by a plurality of PAL users, each indicating a frequency band and an interference margin provided by a respective PAL user; or
an interference margin allocation scheme proposed cooperatively by a plurality of PAL users, indicating a frequency band and an interference margin provided cooperatively by the plurality of PAL users.
3). The electronic device according to 1) or 2), wherein the at least one interference margin allocation scheme has been verified as being feasible by the SAS and has a respective scheme ID.
4). The electronic device according to 3), wherein the CBRS system spectrum access procedure includes:
sending, to the SAS, a spectrum inquiry request containing the scheme ID associated with the particular interference margin allocation scheme;
receiving, from the SAS, a spectrum inquiry response;
sending, to the SAS, a Grant request; and
receiving, from the SAS, a Grant response.
5). The electronic device according to 1) or 2), wherein the processing circuitry is further configured to
in case of completion of the CBRS system spectrum access procedure, inform said PAL user and/or a PAL user that proposed the particular interference margin allocation scheme.
6). The electronic device according to 5), wherein the processing circuitry is further configured to
when the CBRS system spectrum access procedure is successful, pay fees to said PAL user and/or the PAL user that proposed the particular interference margin allocation scheme.
7). The electronic device according to 1) or 2), wherein a blockchain is formed with said PAL user and other PAL users.
8). An electronic device for a Priority Access License (PAL) user, comprising:
processing circuitry configured to
   receive, from a General Authorized Access (GAA) user, an inquiry for spectrum availability information on a Citizen Broadband Radio Service (CBRS) system; and
   in absence of available frequency bands, send to the GAA user at least one interference margin allocation scheme proposed by one or more PAL users.
9). The electronic device according to 8), wherein the at least one interference margin allocation scheme includes one of the following:
an interference margin allocation scheme proposed by said PAL user or another PAL user, indicating a frequency band and an interference margin provided by said PAL user or the another PAL user;
a plurality of interference margin allocation schemes proposed by a plurality of PAL users, each indicating a frequency band and an interference margin provided by a respective PAL user; or
an interference margin allocation scheme proposed cooperatively by a plurality of PAL users, indicating a frequency band and an interference margin provided cooperatively by the plurality of PAL users.
10). The electronic device according to 8) or 9), wherein the processing circuitry is further configured to:
inquire a Spectrum Access System (SAS) for feasibility of interference margin allocation schemes; and
send, to the GAA user, the at least one interference margin allocation scheme that has been verified as being feasible by the SAS and respective scheme ID set by the SAS.
11). The electronic device according to 10), wherein the processing circuitry is further configured to:
send, to the SAS, a heartbeat request; and
receive, from the SAS, a heartbeat response which instructs said PAL user to adjust operational parameters according to the inference margin allocation scheme proposed by it.
12). The electronic device according to 8) or 9), wherein a blockchain is formed with said PAL user and other PAL users.
13). The electronic device according to 12), wherein the processing circuitry is further configured to:
broadcast the inquiry for spectrum availability information from the GAA user over the blockchain.
14). The electronic device according to 12), wherein the processing circuitry is further configured to:
receive fees paid by the GAA user; and
pack transaction information related to the inference margin into a block for verification by other PAL users on the blockchain.
15). An electronic device for a Priority Access License (PAL) user, comprising:
processing circuitry configured to
   in response to an inquiry for spectrum availability information on a Citizen Broadband Radio Service (CBRS) system from a General Authorized Access (GAA) user broadcast by another PAL user, propose an interference margin allocation scheme indicating a frequency band and an interference margin that can be provided to the GAA user by the PAL user; and
   send the interference margin allocation scheme to the another PAL user.
16). The electronic device according to 15), wherein the processing circuitry is further configured to:
send, to the SAS, a heartbeat request; and
receive, from the SAS, a heartbeat response which instructs said PAL user to adjust operational parameters according to the inference margin allocation scheme.
17). The electronic device according to 15), wherein the processing circuitry is further configured to:
in a case where the interference margin allocation scheme is adopted by the GAA user, receive fees paid by the GAA user; and
pack transaction information related to the inference margin into a block for verification by other PAL users on a blockchain.
18). A communication method, comprising:
inquiring a Priority Access License (PAL) user for spectrum availability information on a Citizen Broadband Radio Service (CBRS) system;
in absence of available frequency bands, receiving from said PAL user at least one interference margin allocation scheme proposed by one or more PAL users;
based on a particular interference margin allocation scheme of the at least one interference margin allocation scheme, initiating a CBRS system spectrum access procedure with a Spectrum Access System (SAS).
19). A communication method, comprising:
receiving, from a General Authorized Access (GAA) user, an inquiry for spectrum availability information on a Citizen Broadband Radio Service (CBRS) system; and
in absence of available frequency bands, sending to the GAA user at least one interference margin allocation scheme proposed by one or more PAL users.
20). A computer program product comprising executable instructions which, when executed, implement the communication method according to 18) or 19).

### Application Examples of the Present Disclosure

The technology of the present disclosure can be applied to various products.

For example, the electronic device 100 according to the embodiments of the present disclosure can be implemented as or installed in a variety of CBSDs of a GAA user, and the electronic device 200 or 300 can be implemented as or installed in a variety of CBSDs of a PAL user.

The communication methods according to the embodiments of the present disclosure may be implemented by various devices in the CBRS or another technology; the methods and operations according to the embodiments of the present disclosure may be embodied as computer-executable instructions, stored in a non-transitory computer-readable storage medium, and can be performed by various base stations or user devices to implement one or more of the above-mentioned functions.

The technology according to the embodiments of the present disclosure can be made into various computer program products, which can be used in various devices in the CBRS or another technology to implement one or more of the above-mentioned functions.

Examples of CBSD of a GAA user or a PAL user as described in the present disclosure include a wireless access point, a base station in a private LTE network, a WIFI hotspot and the like. It should be noted that the “base station” used in the present disclosure is an example of a control device on the network side, and has a full breadth of its usual meaning. The base stations mentioned in the present disclosure can be implemented as any type of base stations, preferably, such as the macro gNB or ng-eNB defined in the 3GPP 5G NR standard. A gNB may be a gNB that covers a cell smaller than a macro cell, such as a pico gNB, a micro gNB, and a home (femto) gNB. Instead, the base station may be implemented as any other types of base stations such as a NodeB, an eNodeB and a base transceiver station (BTS). The base station may include a main body configured to control wireless communication, and one or more remote radio heads (RRH), a wireless relay, a drone control tower, a control node in an automated factory or the like disposed in a different place from the main body.

Moreover, in the present disclosure, the “End User Device (EUD)” served by a GAA user or a PAL user has a full breadth of its usual meaning, including various terminal devices or in-vehicle devices communicating with the base station. The EUD may be implemented as a mobile terminal such as a smartphone, a tablet personal computer (PC), a notebook PC, a portable game terminal, a portable/dongle type mobile router, and a digital camera apparatus, or an in-vehicle terminal such as a car navigation device. The EUD may also be implemented as a terminal (that is also referred to as a machine type communication (MTC) terminal) that performs machine-to-machine (M2M) communication, a drone, a sensor or actuator in an automated factory or the like. Furthermore, the user device may be a wireless communication module (such as an integrated circuit module including a single die) mounted on each of the above terminals.

Examples of the base station in which the present disclosure can be applied will be described briefly below.

### First Application Example of Base Station

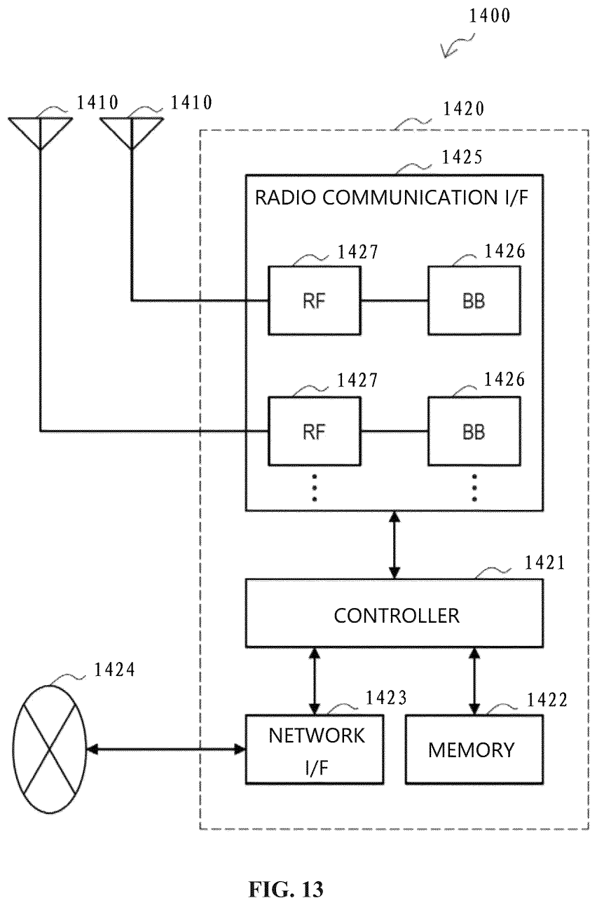

FIG. 13 is a block diagram showing a first example of a schematic configuration of a base station to which the technology of the present disclosure can be applied. In FIG. 13, the base station is implemented as gNB 1400. The gNB 1400 includes a plurality of antennas 1410 and a base station device 1420. The base station device 1420 and each antenna 1410 may be connected to each other via an RF cable. In an implementation manner, the gNB 1400 (or the base station device 1420) herein may correspond to any of the above-mentioned electronic device 100, 200 or 300.

The antennas 1410 includes multiple antenna elements, such as multiple antenna arrays for large-scale MIMO. The antennas 1410, for example, can be arranged into a matrix of antenna arrays, and are used by the base station device 1420 to transmit and receive wireless signals. For example, multiple antennas 1410 may be compatible with multiple frequency bands used by gNB 1400.

The base station device 1420 includes a controller 1421, a memory 1422, a network interface 1423, and a radio communication interface 1425.

The controller 1421 may be, for example, a CPU or a DSP, and operates various functions of the base station device 1420 at a higher layer. For example, the controller 1421 may include any of the processing circuitry 101, 201 or 301 as described above, perform the communication method described in FIG. 10B, 11B or 12B, or control various components of the electronic device 100, 200 or 300. For example, the controller 1421 generates data packets based on data in signals processed by the radio communication interface 1425, and passes the generated packets via the network interface 1423. The controller 1421 may bundle data from multiple baseband processors to generate bundled packets, and pass the generated bundled packets. The controller 1421 may have logical functions that perform controls such as radio resource control, radio bearer control, mobility management, admission control, and scheduling. The controls can be performed in conjunction with a nearby gNB or core network node. The memory 1422 includes a RAM and a ROM, and stores a program executed by the controller 1421 and various types of control data such as a terminal list, transmission power data, and scheduling data.

The network interface 1423 is a communication interface for connecting the base station device 1420 to the core network 1424. The controller 1421 may communicate with a core network node or another gNB via the network interface 1423. In this case, the gNB 1400 and the core network node or other gNBs may be connected to each other through a logical interface such as an NG interface and an X2 interface. The network interface 1423 may also be a wired communication interface or a radio communication interface for a wireless backhaul line. If the network interface 1423 is a radio communication interface, compared with the frequency band used by the radio communication interface 1425, the network interface 1423 can use a higher frequency band for wireless communication.

The radio communication interface 1425 supports any cellular communication scheme such as 5G NR, and provides a wireless connection to a terminal located in a cell of the gNB 1400 via an antenna 1410. The radio communication interface 1425 may generally include, for example, a baseband (BB) processor 1426 and an RF circuit 1427. The BB processor 1426 may perform, for example, encoding/decoding, modulation/demodulation, and multiplexing/demultiplexing, and execute various types of signal processing in layers such as the physical layer, the MAC layer, the RLC layer, the PDCP layer and the SDAP layer. As an alternative of the controller 1421, the BB processor 1426 may have a part or all of the above-mentioned logical functions. The BB processor 1426 may be a memory storing a communication control program, or a module including a processor and related circuits configured to execute the program. Updating the program can change the function of the BB processor 1426. The module may be a card or a blade inserted into a slot of the base station device 1420. Alternatively, the module may be a chip mounted on a card or a blade. Meanwhile, the RF circuit 1427 may include, for example, a mixer, a filter, and an amplifier, and transmits and receives a wireless signal via the antenna 1410. Although FIG. 13 illustrates an example in which one RF circuit 1427 is connected to one antenna 1410, the present disclosure is not limited to this illustration, but one RF circuit 1427 may be connected to multiple antennas 1410 at the same time.

As shown in FIG. 13, the radio communication interface 1425 may include a plurality of BB processors 1426. For example, the plurality of BB processors 1426 may be compatible with multiple frequency bands used by gNB 1400. As shown in FIG. 13, the radio communication interface 1425 may include a plurality of RF circuits 1427. For example, the plurality of RF circuits 1427 may be compatible with multiple antenna elements. Although FIG. 13 shows an example in which the radio communication interface 1425 includes a plurality of BB processors 1426 and a plurality of RF circuits 1427, the radio communication interface 1425 may also include a single BB processor 1426 or a single RF circuit 1427.

In the gNB 1400 illustrated in FIG. 13, one or more of the units included in the processing circuitry 101 described with reference to FIG. 10A, the processing circuitry 201 described with reference to FIG. 11A, or the processing circuitry 301 described with reference to FIG. 12A may be implemented in the radio communication interface 1425. Alternatively, at least a part of these components may be implemented in the controller 1421. As an example, the gNB 1400 includes a part (for example, the BB processor 1426) or the entire of the radio communication interface 1425 and/or a module including the controller 1421, and the one or more components may be implemented in the module. In this case, the module may store a program (in other words, a program causing the processor to execute operations of the one or more components) causing the processor to function as the one or more components, and execute the program. As another example, a program causing the processor to function as the one or more components may be installed in the gNB 1400, and the radio communication interface 1425 (for example, the BB processor 1426) and/or the controller 1421 may execute the program. As described above, as a device including the one or more components, the gNB 1400, the base station device 1420 or the module may be provided. In addition, a readable medium in which the program is recorded may be provided.

### Second Application Example of Base Station

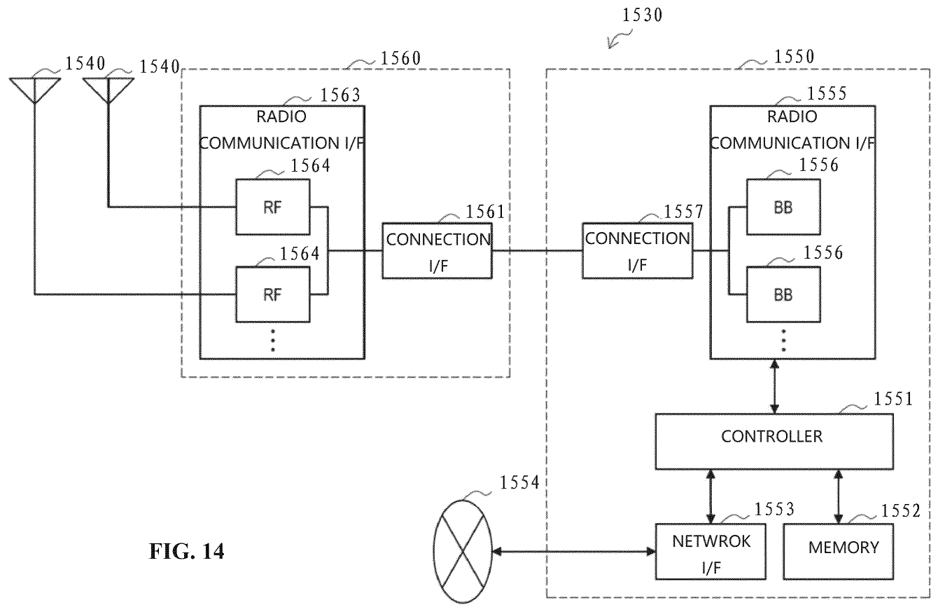

FIG. 14 is a block diagram showing a second example of a schematic configuration of a base station to which the technology of the present disclosure can be applied. In FIG. 14, the base station is shown as gNB 1530. The gNB 1530 includes multiple antennas 1540, base station equipment 1550, and RRH 1560. The RRH 1560 and each antenna 1540 may be connected to each other via an RF cable. The base station equipment 1550 and the RRH 1560 may be connected to each other via a high-speed line such as a fiber optic cable. In an implementation manner, the gNB 1530 (or the base station device 1550) herein may correspond to the above-mentioned electronic device 100, 200, or 300.

The antennas 1540 includes multiple antenna elements, such as multiple antenna arrays for large-scale MIMO. The antennas 1540, for example, can be arranged into a matrix of antenna arrays, and are used by the base station device 1550 to transmit and receive wireless signals. For example, multiple antennas 1540 may be compatible with multiple frequency bands used by gNB 1530.

The base station device 1550 includes a controller 1551, a memory 1552, a network interface 1553, a radio communication interface 1555, and a connection interface 1557. The controller 1551, the memory 1552, and the network interface 1553 are the same as the controller 1421, the memory 1422, and the network interface 1423 described with reference to FIG. 13.

The radio communication interface 1555 supports any cellular communication scheme such as 5G NR, and provides wireless communication to a terminal located in a sector corresponding to the RRH 1560 via the RRH 1560 and the antenna 1540. The radio communication interface 1555 may typically include, for example, a BB processor 1556. The BB processor 1556 is the same as the BB processor 1426 described with reference to FIG. 13 except that the BB processor 1556 is connected to the RF circuit 1564 of the RRH 1560 via the connection interface 1557. As shown in FIG. 14, the radio communication interface 1555 may include a plurality of BB processors 1556. For example, multiple BB processors 1556 may be compatible with multiple frequency bands used by gNB 1530. Although FIG. 14 shows an example in which the radio communication interface 1555 includes a plurality of BB processors 1556, the radio communication interface 1555 may also include a single BB processor 1556.

The connection interface 1557 is an interface for connecting the base station device 1550 (radio communication interface 1555) to the RRH 1560. The connection interface 1557 may also be a communication module for communication in the above-mentioned high-speed line connecting the base station device 1550 (radio communication interface 1555) to the RRH 1560.

The RRH 1560 includes a connection interface 1561 and a radio communication interface 1563.

The connection interface 1561 is an interface for connecting the RRH 1560 (radio communication interface 1563) to the base station device 1550. The connection interface 1561 may also be a communication module for communication in the above-mentioned high-speed line.

The radio communication interface 1563 transmits and receives wireless signals via the antenna 1540. The radio communication interface 1563 may generally include, for example, an RF circuit 1564. The RF circuit 1564 may include, for example, a mixer, a filter, and an amplifier, and transmits and receives wireless signals via the antenna 1540. Although FIG. 14 illustrates an example in which one RF circuit 1564 is connected to one antenna 1540, the present disclosure is not limited to this illustration, but one RF circuit 1564 may be connected to multiple antennas 1540 at the same time.

As shown in FIG. 14, the radio communication interface 1563 may include a plurality of RF circuits 1564. For example, the plurality of RF circuits 1564 may support multiple antenna elements. Although FIG. 14 shows an example in which the radio communication interface 1563 includes a plurality of RF circuits 1564, the radio communication interface 1563 may include a single RF circuit 1564.

In the gNB 1500 shown in FIG. 14, one or more units included in the processing circuitry 101 described with reference to FIG. 10A, the processing circuitry 201 described with reference to FIG. 11A, or the processing circuitry 301 described with reference to FIG. 12A may be implemented in the radio communication interface 1525. Alternatively, at least a part of these components may be implemented in the controller 1521. For example, the gNB 1500 includes a part (for example, the BB processor 1526) or the whole of the radio communication interface 1525, and/or a module including the controller 1521, and one or more components may be implemented in the module. In this case, the module may store a program for allowing the processor to function as one or more components (in other words, a program for allowing the processor to perform operations of one or more components), and may execute the program. As another example, a program for allowing the processor to function as one or more components may be installed in the gNB 1500, and the radio communication interface 1525 (for example, the BB processor 1526) and/or the controller 1521 may execute the program. As described above, as a device including one or more components, the gNB 1500, the base station device 1520, or a module may be provided, and a program for allowing the processor to function as one or more components may be provided. In addition, a readable medium in which the program is recorded may be provided.

Although the illustrative embodiments of the present disclosure have been described with reference to the accompanying drawings, the present disclosure is certainly not limited to the above examples. Those skilled in the art may achieve various adaptions and modifications within the scope of the appended claims, and it will be appreciated that these adaptions and modifications certainly fall into the scope of the technology of the present disclosure.

For example, in the above embodiments, the multiple functions included in one module may be implemented by separate means. Alternatively, in the above embodiments, the multiple functions included in multiple modules may be implemented by separate means, respectively. In additions, one of the above functions may be implemented by multiple modules. Needless to say, such configurations are included in the scope of the technology of the present disclosure.

In this specification, the steps described in the flowcharts include not only the processes performed sequentially in chronological order, but also the processes performed in parallel or separately but not necessarily performed in chronological order. Furthermore, even in the steps performed in chronological order, needless to say, the order may be changed appropriately.

Although the present disclosure and its advantages have been described in detail, it will be appreciated that various changes, replacements and transformations may be made without departing from the spirit and scope of the present disclosure as defined by the appended claims. In addition, the terms “include”, “comprise” or any other variants of the embodiments of the present disclosure are intended to be non-exclusive inclusion, such that the process, method, article or device including a series of elements includes not only these elements, but also those that are not listed specifically, or those that are inherent to the process, method, article or device. In case of further limitations, the element defined by the sentence “include one” does not exclude the presence of additional same elements in the process, method, article or device including this element.

1. An electronic device for a General Authorized Access (GAA) user, comprising:
processing circuitry configured to
inquire a Priority Access License (PAL) user for spectrum availability information on a Citizen Broadband Radio Service (CBRS) system;
in absence of available frequency bands, receive from said PAL user at least one interference margin allocation scheme proposed by one or more PAL users;
based on a particular interference margin allocation scheme of the at least one interference margin allocation scheme, initiate a CBRS system spectrum access procedure with a Spectrum Access System (SAS).

2. The electronic device according to claim 1, wherein the at least one interference margin allocation scheme includes one of the following:
an interference margin allocation scheme proposed by said PAL user or another PAL user, indicating a frequency band and an interference margin provided by said PAL user or the another PAL user;
a plurality of interference margin allocation schemes proposed by a plurality of PAL users, each indicating a frequency band and an interference margin provided by a respective PAL user; or
an interference margin allocation scheme proposed cooperatively by a plurality of PAL users, indicating a frequency band and an interference margin provided cooperatively by the plurality of PAL users.

3. The electronic device according to claim 1, wherein the at least one interference margin allocation scheme has been verified as being feasible by the SAS and has a respective scheme ID.

4. The electronic device according to claim 3, wherein the CBRS system spectrum access procedure includes:
sending, to the SAS, a spectrum inquiry request containing the scheme ID associated with the particular interference margin allocation scheme;
receiving, from the SAS, a spectrum inquiry response;
sending, to the SAS, a Grant request; and
receiving, from the SAS, a Grant response.

5. The electronic device according to claim 1, wherein the processing circuitry is further configured to
in case of completion of the CBRS system spectrum access procedure, inform said PAL user and/or a PAL user that proposed the particular interference margin allocation scheme.

6. The electronic device according to claim 5, wherein the processing circuitry is further configured to
when the CBRS system spectrum access procedure is successful, pay fees to said PAL user and/or the PAL user that proposed the particular interference margin allocation scheme.

7. The electronic device according to claim 1, wherein a blockchain is formed with said PAL user and other PAL users.

8. An electronic device for a Priority Access License (PAL) user, comprising:
processing circuitry configured to
receive, from a General Authorized Access (GAA) user, an inquiry for spectrum availability information on a Citizen Broadband Radio Service (CBRS) system; and
in absence of available frequency bands, send to the GAA user at least one interference margin allocation scheme proposed by one or more PAL users.

9. The electronic device according to claim 8, wherein the at least one interference margin allocation scheme includes one of the following:
an interference margin allocation scheme proposed by said PAL user or another PAL user, indicating a frequency band and an interference margin provided by said PAL user or the another PAL user;
a plurality of interference margin allocation schemes proposed by a plurality of PAL users, each indicating a frequency band and an interference margin provided by a respective PAL user; or
an interference margin allocation scheme proposed cooperatively by a plurality of PAL users, indicating a frequency band and an interference margin provided cooperatively by the plurality of PAL users.

10. The electronic device according to claim 8, wherein the processing circuitry is further configured to:
inquire a Spectrum Access System (SAS) for feasibility of interference margin allocation schemes; and
send, to the GAA user, the at least one interference margin allocation scheme that has been verified as being feasible by the SAS and respective scheme ID set by the SAS.

11. The electronic device according to claim 10, wherein the processing circuitry is further configured to:
send, to the SAS, a heartbeat request; and
receive, from the SAS, a heartbeat response which instructs said PAL user to adjust operational parameters according to the inference margin allocation scheme proposed by it.

12. The electronic device according to claim 8, wherein a blockchain is formed with said PAL user and other PAL users.

13. The electronic device according to claim 12, wherein the processing circuitry is further configured to:
broadcast the inquiry for spectrum availability information from the GAA user over the blockchain.

14. The electronic device according to claim 12, wherein the processing circuitry is further configured to:
receive fees paid by the GAA user; and
pack transaction information related to the inference margin into a block for verification by other PAL users on the blockchain.

15. An electronic device for a Priority Access License (PAL) user, comprising:
processing circuitry configured to
in response to an inquiry for spectrum availability information on a Citizen Broadband Radio Service (CBRS) system from a General Authorized Access (GAA) user broadcast by another PAL user, propose an interference margin allocation scheme indicating a frequency band and an interference margin that can be provided to the GAA user by the PAL user; and
send the interference margin allocation scheme to the another PAL user.

16. The electronic device according to claim 15, wherein the processing circuitry is further configured to:
send, to the SAS, a heartbeat request; and
receive, from the SAS, a heartbeat response which instructs said PAL user to adjust operational parameters according to the inference margin allocation scheme.

17. The electronic device according to claim 15, wherein the processing circuitry is further configured to:
in a case where the interference margin allocation scheme is adopted by the GAA user, receive fees paid by the GAA user; and
pack transaction information related to the inference margin into a block for verification by other PAL users on a blockchain.

18. A communication method, comprising:
inquiring a Priority Access License (PAL) user for spectrum availability information on a Citizen Broadband Radio Service (CBRS) system;
in absence of available frequency bands, receiving from said PAL user at least one interference margin allocation scheme proposed by one or more PAL users;
based on a particular interference margin allocation scheme of the at least one interference margin allocation scheme, initiating a CBRS system spectrum access procedure with a Spectrum Access System (SAS).

19. A communication method, comprising:
receiving, from a General Authorized Access (GAA) user, an inquiry for spectrum availability information on a Citizen Broadband Radio Service (CBRS) system; and
in absence of available frequency bands, sending to the GAA user at least one interference margin allocation scheme proposed by one or more PAL users.

20. A computer program product including executable instructions which, when executed, implement the communication method of claim 18.
